(19) United States
(12) Patent Application Publication
(10) Pub. No.: US 2014/0136628 A1
(43) Pub. Date: May 15, 2014

(54) SNAIL TO ELECTRONIC MAIL CONVERSION

(71) Applicant: OUTBOX, INC., Austin, TX (US)

(72) Inventors: William Jewell Davis, JR., Austin, TX (US); Evan John Baehr, Austin, TX (US); Jason Gregory Seriff, Austin, TX (US); Donald Stephen Haga, III, Austin, TX (US); Michael Joseph Dellanoce, Austin, TX (US)

(73) Assignee: OUTBOX, Inc., Austin, TX (US)

(21) Appl. No.: 13/672,843

(22) Filed: Nov. 9, 2012

(51) Int. Cl. G06F 15/16

(52) U.S. Cl. 709/206

(57) ABSTRACT

The present invention generally relates to turning snail mail into electronic mail. The snail mail is delivered to the intended recipient's mailbox and then retrieved (i.e., intercepted by a third party) before the intended recipient receives the snail mail from the mailbox. The retrieved mail is then converted into an electronic file that is stored on a server. The intended recipient of the snail mail may then access the electronic file to view the snail mail in electronic format. If desired, the intended recipient can request delivery of the actual snail mail after viewing the electronic file.

### BACKGROUND OF THE INVENTION

1. Field of the Invention

Embodiments of the present invention generally relate to converting paper-based mail typically received from a postal carrier (i.e., snail mail) into electronic mail.

2. Description of the Related Art

It is a digital world, yet most people are still tethered to their mailbox to receive bills and other paper-based communications. Many households have access to the internet and are moving to paperless bill-pay whereby the bill is never printed in paper form, but rather, is delivered electronically to the intended recipient. Not all businesses are sophisticated enough to have electronic delivery of bills and thus rely upon paper-based communication. Therefore, to date, some bills (and incidentally, the rest of the paper-based mail) are delivered by the postal carrier and complete elimination of snail mail has not happened.

Additionally, when people travel, oftentimes they will have someone pick up their snail mail for them. Alternatively, rather than have someone pick up their snail mail, people will make a special trip to their local Post Office and complete paperwork to have the United States Postal Service (USPS) stop delivery of snail mail for a specified period of time. Of course, during the time on travel, the snail mail is at home (or at the Post Office) and not accessible.

Thus, there is a need in the art for a more convenient manner of receiving snail mail delivered by the USPS.

### SUMMARY OF THE INVENTION

The present invention generally relates to turning snail mail into electronic mail. The snail mail is delivered to the intended recipient's mailbox and then retrieved (i.e., intercepted by a third party) before the intended recipient collects the snail mail from the mailbox. The retrieved mail is then converted into an electronic file that is stored on a server. The intended recipient of the snail mail may then access the electronic file to view the snail mail in electronic format. If desired, the intended recipient can request delivery of the actual snail mail after viewing the electronic file.

In one embodiment, a method comprises retrieving paper based mail (i.e., snail mail) addressed to an intended recipient at the mailbox that services the intended recipient's residence or business; converting the retrieved mail into an electronic file of the retrieved mail; and permitting access to the electronic file by the intended recipient.

In another embodiment, a method of converting snail mail into electronic mail comprises retrieving snail mail that is addressed to an intended recipient from a mailbox that services the intended recipient's residence or business; sorting the snail mail into first class mail and second class mail; converting the first class mail into an electronic file of the first class mail; and permitting access to the electronic file by the intended recipient.

In another embodiment, a method of converting snail mail into electronic mail comprises retrieving snail mail that is addressed to an intended recipient from the intended recipient's mailbox that services the intended recipient's residence or business; converting the snail mail into one or more electronic files containing images of the snail mail; and permitting access to the electronic file by the intended recipient at a resolution selected by the intended recipient. The converting comprises taking a digital image of the mail, the digital image containing a background having a contrast with the mail; removing the background from the digital image to create a modified image; and saving the modified image as a plurality of electronic files, each file having a different resolution.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a flowchart illustrating the process of converting snail mail into electronic mail according to one embodiment.

FIG. 2 shows an envelope on a background for imaging purposes.

FIG. 3 illustrates a computing system configured for delivering electronic mail, according to one embodiment.

FIG. 4 is a more detailed view of a mail server of FIG. 3 within which embodiments of the invention may be implemented.

FIG. 5 illustrates an example of a computing system used view online content, according to certain embodiments of the present disclosure.

FIG. 6 is a flowchart illustrating the process of converting snail mail into electronic mail according to another embodiment.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

The present invention generally relates to turning snail mail into electronic mail. The snail mail is delivered to the intended recipient's mailbox and then retrieved (i.e., intercepted by a third party) before the intended recipient receives the snail mail from the mailbox. The retrieved mail is then converted into an electronic file that is stored on a server. The intended recipient of the snail mail may then access the electronic file to view the snail mail in electronic format. If desired, the intended recipient can request delivery of the actual snail mail after viewing the electronic file.

In operation, the intended recipient signs-up with an electronic mail delivery service, such as Outbox, Inc., and authorizes the electronic mail delivery service to retrieve the intended recipient's paper-based mail (i.e., snail mail) and then deliver the paper-based mail in an electronic format. The electronic mail delivery service could be authorized to retrieve all mail (excluding packages). Packages could continue to be delivered through the USPS. In one embodiment, the electronic mail delivery service can be authorized to retrieve all mail, including packages. Once retrieved, the paper-based mail would be converted by the electronic mail delivery service into an electronic format. The electronic mail would then be available to the intended recipient.

### Retrieval at the Mailbox

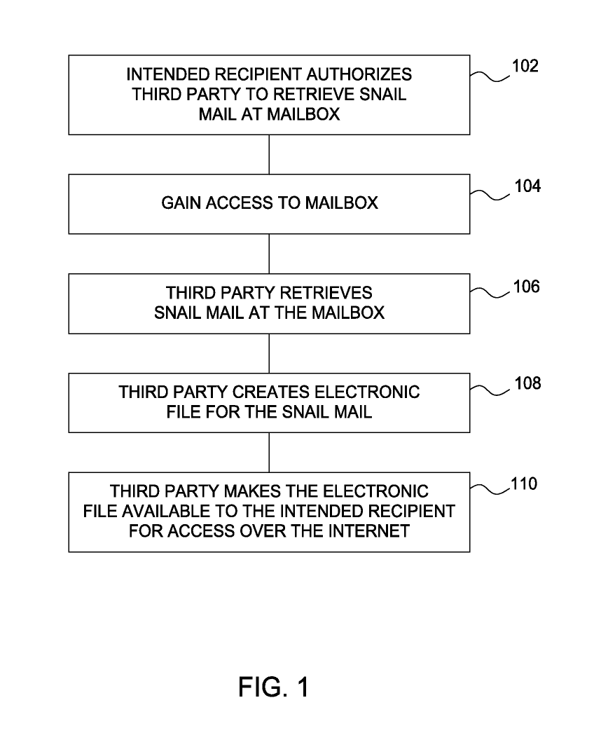

FIG. 1 is a flowchart illustrating the process of converting snail mail into electronic mail according to one embodiment. In order to begin the process, the intended recipient of the snail mail authorizes a third party electronic mail delivery service, such as Outbox, Inc., to retrieve the snail mail at the intended recipient's mailbox (step 102). The third party will then be able to retrieve the snail mail, after the USPS has delivered the snail mail to the mailbox, but before the intended recipient retrieves the mail from the mailbox.

It is important to understand the difference between retrieving the snail mail from the intended recipient's mailbox and receiving the snail mail from a mailbox that the intended recipient has requested snail mail be sent. In the latter, the intended recipient has either requested the USPS to forward the mail to another location (in which case, the intended recipient's address is still on the snail mail, but the USPS has added a new address label with the forwarding address) or has arranged for all mail to be addressed to a different location (e.g., an address in Oregon) than where the intended recipient actually resides. Either way, for ‘receiving’ the mail, the intended recipient needs to make a specific effort to change the location of where the snail mail is delivered. Retrieving the snail mail, on the other hand, simply involves collecting the snail mail from the mailbox at the address of the intended recipient where the intended recipient resides or operates a business. Another manner of considering the situation is that to ‘receive’ the snail mail, the intended recipient has designated the mailbox to which the snail mail is delivered by the USPS. To ‘retrieve’ snail mail, the third party collects the mail from the mailbox that services the intended recipient's residence (or business).

If the mailbox is a rural mailbox, the third party is ready to retrieve the mail. If, however, the mailbox is a community mailbox or other mailbox whereby the intended recipient utilizes a lock on the mailbox, the third party needs to gain access to the mailbox (step 104). To gain access, the third party may copy the key or change the lock. In order to copy the key, the third party may obtain the key and make a copy of the key. Alternatively, the intended recipient may take a picture or image of the key and send the image or picture to the third party. The third party may then make a key based upon the image or picture. Thus, the third party has the ability to create a new key without physical possession of the original key. Once the third party has gained access to the mailbox the third party may now begin to retrieve and convert snail mail to electronic mail on a regular basis for the intended recipient.

Snail mail delivered by the USPS comes in many forms. There is first class mail which includes such items as personal letters, birthday cards, bills, and bank statements to name a few. There is also second class mail which includes magazines and newspapers. Additionally, there is third class mail which includes mass mailings such as direct mail advertisements. Packages are oftentimes considered first class mail, but are considered a different type of mail as packages tend to weigh more than the standard first class mail and are typically bulkier than standard first class mail. In one embodiment, the third party is authorized to intercept first, second, and third class mail, but not to intercept packages. In another embodiment, the third party is authorized to intercept all mail that is delivered to the mailbox.

No matter what level of authorization (i.e., first class, second class, third class, packages), the third party then proceeds to intercept the snail mail everyday that mail is delivered to the mailbox, which is typically Monday-Saturday, except holidays. When the third party intercepts the snail mail, the third party receives the snail mail at the mailbox (step 106). Any packages that may be present in the mailbox are hand delivered to the intended recipient. The third party can retrieve the snail mail by well known means such as a representative of the third party going to specified mailbox and retrieving the snail mail.

Now that the third party has intercepted/retrieved the snail mail, the third party can sort the mail into the various classes of mail (i.e., first class, second class, third class) and then convert the snail mail into electronic mail (step 108). The snail mail may be converted in a number of ways such as scanning the snail mail to create an electronic file or taking a digital image of the snail mail to create an electronic file as will be discussed below. The electronic file with then be available to the intended recipient over the internet (step 110). In one embodiment, the electronic files for only the first class mail will be made available to the intended recipient. In another embodiment, all of the snail mail images (excluding packages) received by the third party will be make available to the intended recipient.

The snail mail will be maintained by the third party for an agreed upon time period, such as about 30 days, after which, the snail mail will be shredded. Upon viewing the electronic mail, the intended recipient may request the original snail mail to be delivered. Upon receiving such a request, the third party will hand deliver the original snail mail. If the third party retrieves any, the third party will hand deliver the package to the intended recipient.

To convert the snail mail to electronic mail, the third party opens the snail mail and removes the contents from the envelopes. The envelope, and the contents, and converted to electronic files. In one embodiment, the envelopes and contents are scanned to create electronic files. In another embodiment, digital images are taken of the envelopes and contents to create electronic files.

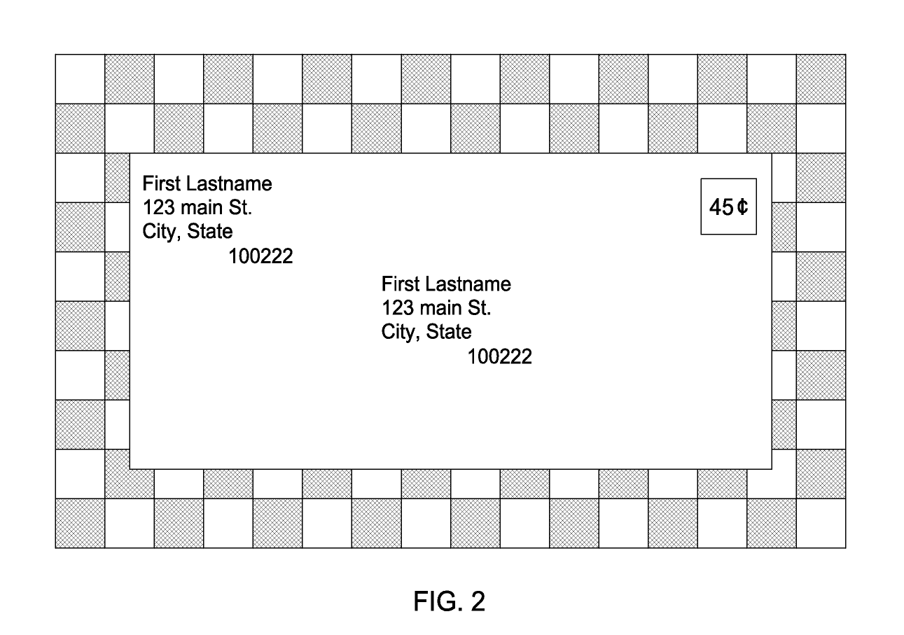

For digital images, an envelope of snail mail is placed onto a checkerboard background, such as shown in FIG. 2, to provide a contrast between the item to be imaged (in this case, the envelope) and the background. An image is then taken with a digital camera. The image is then available to the technician at the third party to verify whether the image is acceptable. If the image is not acceptable, a new image is taken. The checkerboard background is an undesired part of the final image, so if the image is acceptable, then the technician removes the background from the image. The checkerboard background provides a contrast to help the technician identify where the envelope ends, and the background begins. If, for example, a plain white background was used and the envelope was white as well, then it would be quite difficult to determine where the background ended and the envelope begins. By utilizing the checkerboard background, or any other contrasting background, the borders of the envelope (or image taken) can be readily determined and the background removed from the image.

Once the background has been removed, the image contains only the envelope and thus has the appearance of the envelope. The technician then saves the image in one or more electronic files. If multiple files are saved, then each file contains the same image, but at different quality levels (i.e., one electronic file will have the image with a first number of megapixels that is greater than the number of megapixels of the image stored in a second file). Each image quality level (i.e., the resolution) will have a different file size. The better the image quality, the larger the file size. The intended recipient can choose which quality of the image to view. Such a selection may be driven by the bandwidth of the internet connection utilized by the intended recipient. Thus, the intended recipient has the ability to select the resolution with which the image will be displayed.

Now that the envelope has been imaged and converted into an electronic file, the contents of the envelope are imaged and converted into electronic files. The contents are imaged in the same manner as the envelope. Specifically, each piece of paper within the envelope is separately imaged on the checkerboard background. The image is analyzed to determine whether or not the image is acceptable. If acceptable, the background is removed and one or more electronic files are created containing the image.

Now that the contents of the envelope have been imaged, the next envelope is processed as are the contents. The process repeats until all of the envelopes for the day's snail mail have been converted into electronic files. Each envelope has multiple images (i.e., at least the envelope and the contents) associated therewith, each of which may have multiple resolutions. All of the day's snail mail is then bundled and sent to storage to await either shredding after the predetermined period of time agreed to by the intended recipient and the third party or to await a request to be delivered to the intended recipient.

The intended recipient can access the electronic files over the internet for the snail mail that would have normally been delivered to their mailbox that day. Thus, the intended recipient receives their mail on the same day that they would otherwise receive their snail mail. The intended recipient can access the electronic files from anywhere in the world having an internet connection.

To view the images, the intended recipient or someone authorized by the intended recipient (i.e., the user) utilizes a computing device (i.e., a smart phone, tablet computer, laptop computer, personal computer, etc.) and accesses the internet whereby the user's computer exchanges information with other computers. For example, when the user requests a webpage, another computer contains the information for the webpage and delivers the information to the user's internet browser.

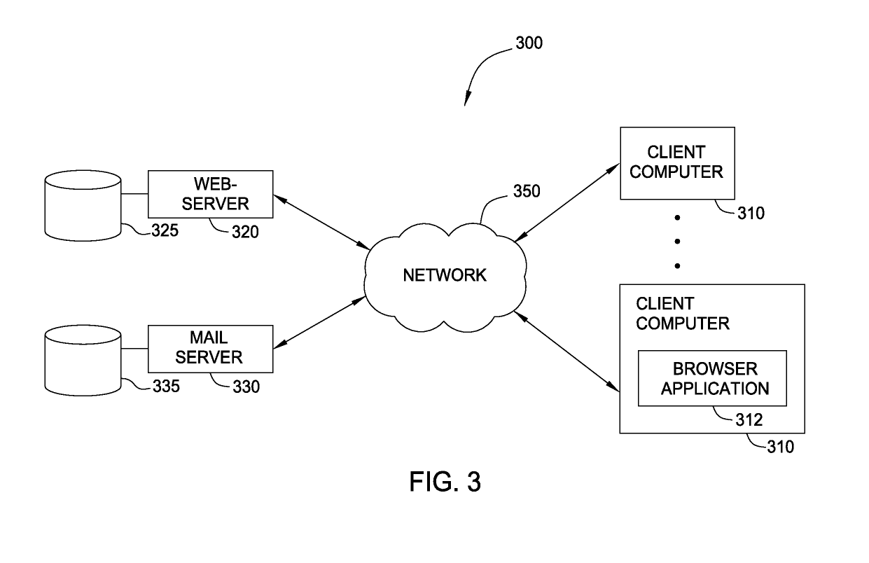

FIG. 3 illustrates a computing system 300 configured for delivering electronic mail, according to one embodiment of the invention. As shown, the computing system 300 includes a web server 320 and a user computer 310 that are each connected to a communications network 350 (e.g., the Internet). For example, the web server 320 may be programmed to communicate with the intended recipient's computer 310 using a networking protocol such as TCP/IP protocol.

The computer 310 may include conventional components of a computing device, e.g., a processor, system memory, a hard disk drive, input devices such as a mouse and a keyboard, and/or output devices, such as a monitor. The web server 320 includes a processor and a system memory (not shown), and may be configured to manage web pages and other media content stored in its respective content storage unit 325 using a file system and/or relational database software. The mail server 330 is a web server configured to manage the electronic mail files that contain the images stored in its respective content storage unit 335. In one embodiment, the mail server 330 may be configured to manage the electronic mail described herein.

In the embodiments of the present invention, the intended recipient operates the user computer 310 that may communicate over the network 350 to request webpages and other media content data from the web server 320. The user computer 310 may be configured to execute a software application, such as a web browser application 312, and access webpages and/or media content data managed by the web server 320 by specifying a uniform resource locator (URL) for the web server 320 into the web browser application 312. The webpages that are displayed to an intended recipient are transmitted from the web server 320 to the computer 310 and processed by the web browser application 312 for display through a monitor of the computer 310.

It is noted that the computer 310 may be a personal computer, laptop, mobile computing device, smart phone, video game console, home digital media player, network-connected television, set top box, and/or other computing devices having components suitable for communicating with the communications network 350.

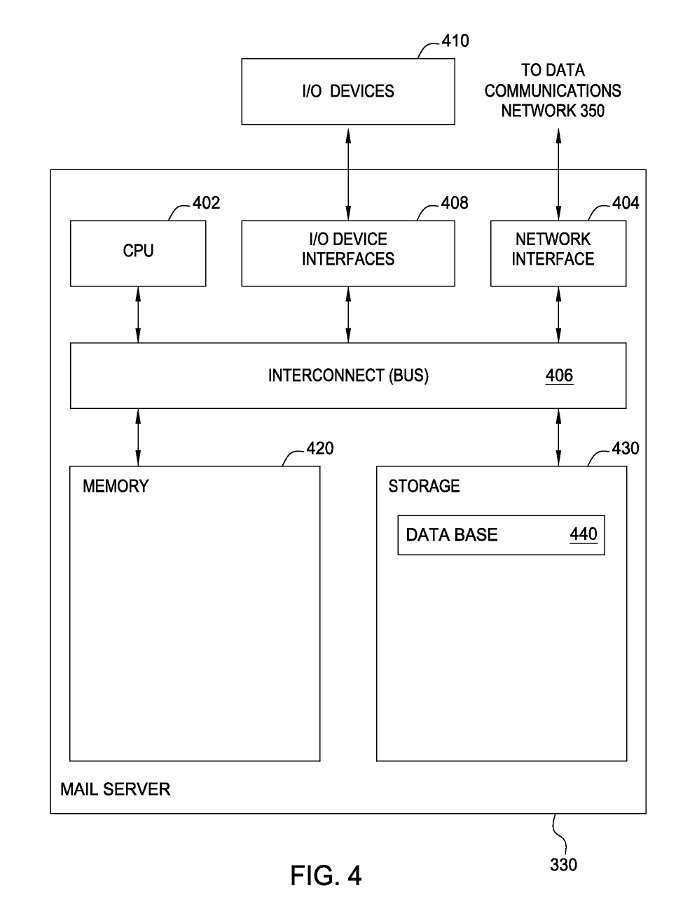

FIG. 4 is a more detailed view of the mail server 330 of FIG. 3 within which embodiments of the invention may be implemented. As shown, the mail server 330 includes, without limitation, a central processing unit (CPU) 402, a network interface 404, memory 420, and storage 430 communicating via an interconnect bus 406. The mail server 330 may also include I/O device interfaces 408 connecting I/O devices 410 (e.g., keyboard, video, mouse, audio). The mail server 330 may further include a network interface 404 configured to transmit data via the communications network 350.

The CPU 402 retrieves and executes programming instructions stored in the memory 420 and generally controls and coordinates operations of other system components. Similarly, the CPU 402 stores and retrieves application data residing in the memory 420. The CPU 402 is included to be representative of a single CPU, multiple CPUs, a single CPU having multiple processing cores, and the like. The interconnect bus 406 is used to transmit programming instructions and application data between the CPU 402, I/O devices interface 408, storage 430, network interface 404, and memory 420.

The memory 420 is generally included to be representative of a random access memory and, in operation, stores software applications and data for use by the CPU 402. Although shown as a single unit, the storage 430 may be a combination of fixed and/or removable storage devices, such as fixed disc drives, floppy disc drives, hard disk drives, flash memory storage drives, tape drives, removable memory cards, CD-ROM, DVD-ROM, Blu-ray, HD-DVD, optical storage, network attached storage (NAS), or a storage area-network (SAN) configured to store non-volatile data.

According to embodiments of the invention, the memory 420 stores instructions and logic for delivering the requested images by the intended recipient. The storage 430 stores snail mail images as electronic files 432 and includes a database 440 configured to store data for associating the respective images with a particular envelope or a particular intended recipient or a particular day of mail. The mail server 330 responds to requests from clients, such as the web browser 330, for snail mail images. In one embodiment, the database 440 comprises a relational database. In one embodiment, the database 440 is any type of storage device.

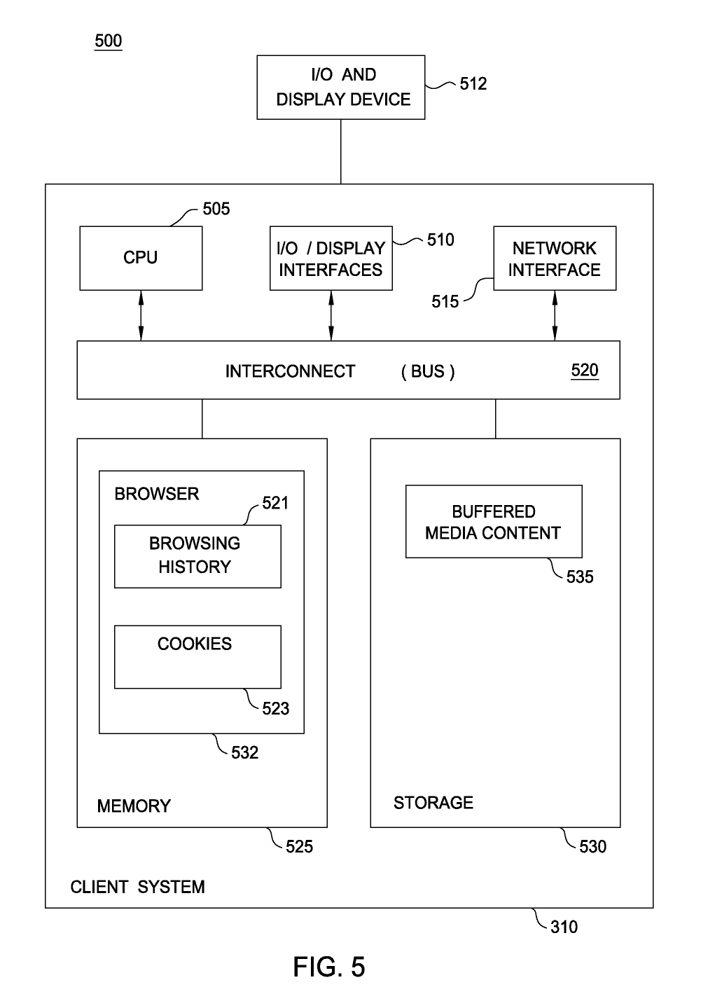

FIG. 5 illustrates an example of a client computing system 310 used to view online content, according to certain embodiments of the present disclosure. As shown, the client computing system 310 includes, without limitation, a central processing unit (CPU) 505, a network interface 515, an interconnect 520, a memory 525, and storage 530. The computing system 310 may also include an I/O device interface 510 connecting I/O devices 512 (e.g., keyboard, display and mouse devices) to the computing system 310.

Like CPU 402, CPU 505 is included to be representative of a single CPU, multiple CPUs, a single CPU having multiple processing cores, etc., and the memory 525 is generally included to be representative of a random access memory. The interconnect 520 is used to transmit programming instructions and application data between the CPU 505, I/O devices interface 510, storage 530, network interface 515, and memory 525. The network interface 515 is configured to transmit data via the communications network 350, e.g., to stream content from the web server 320, as well as to present images of the snail mail from the mail server 330. Storage 530, such as a hard disk drive or solid state (SSD) storage drive, may store non-volatile data. Illustratively, the memory 525 includes a web browser 532, which itself includes a browsing history 521 and cookies 523, and the storage 530 stores buffered media content 535. The browser 532 provides a software application which allows a user to access web pages and other content hosted by a server.

Interception Directly from the USPS

The USPS handles about 45 billion pieces of paper-based bills that are delivered to households each year at a cost of about $65 billion. Additionally, the USPS handles about 20 billion catalogues and 70 billion direct mail mailings a year for a total cost of about $85 billion dollars. Personal mail to individual households is only about 6 billion pieces at a cost of about $12 billion. Once commercial enterprises are factored in, the USPS handles about 171 billion pieces of paper-based mail a year.

An individual household receives, on average 29 bills/statements, 12 catalogues/coupon packets, 45 direct mailings and 4 personal correspondences per month. In fiscal year 2011, the USPS had a $5.1 billion deficit with $70.6 billion in expenses. Of the $70.6 billion in expenses, the “last-mile” service (i.e., the actual delivery from the post office to the intended recipient's address by the mail carrier) accounted for approximately 25% of the USPS's expenses.

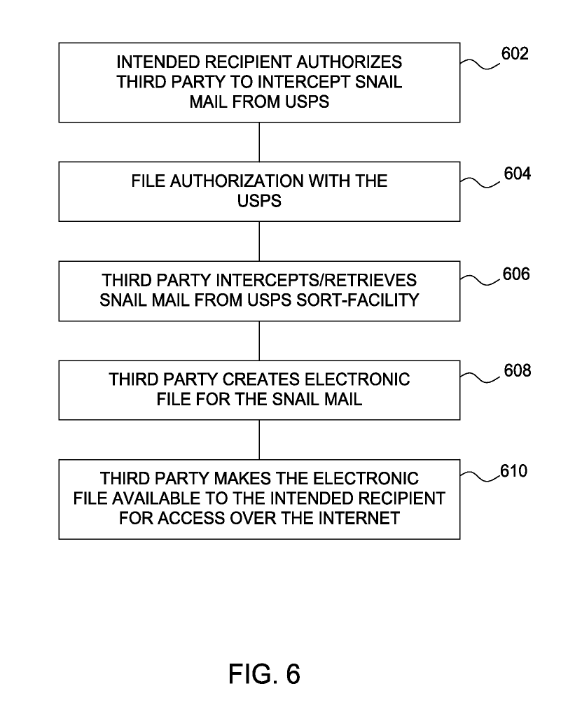

FIG. 6 is a flowchart illustrating the process of converting snail mail into electronic mail according to another embodiment that eliminates/reduces “last-mile” service from the USPS. In order to begin the process, the intended recipient of the snail mail authorizes a third party electronic mail delivery service, such as Outbox, Inc., to intercept the snail mail from the USPS (step 602). Then, either the third party or the intended recipient files the authorization with the USPS (step 604). Once the third party has authorization, and the authorization has been recognized by the USPS, the third party may not begin to convert snail mail to electronic mail on a regular basis for the intended recipient.

Snail mail delivered by the USPS comes in many forms. There is first class mail which includes such items as personal letters, birthday cards, bills, and bank statements to name a few. There is also second class mail which includes magazines and newspapers. Additionally, there is third class mail which includes mass mailings such as direct mail advertisements. Packages are oftentimes considered first class mail, but are considered a different type of mail as packages tend to weigh more than the standard first class mail and are typically bulkier than standard first class mail. In one embodiment, the third party is authorized to intercept first, second, and third class mail, but not to intercept packages.

No matter what level of authorization (i.e., first class, second class, third class, packages), the third party then proceeds to intercept the snail mail everyday that the USPS is open, which is typically Monday-Saturday, except holidays. Alternatively, the third party receives the snail mail that is addressed to the intended recipient. When the third party receives the snail mail, the third party receives the snail mail at a location that is separate from where the snail mail is addressed. The third party retrieves the snail mail from the USPS sorting facility (step 606). The third party can retrieve the snail mail by well known means such as a representative of the third party going to the sorting facility and retrieving the sorted snail mail from the USPS. In order to retrieve the snail mail, the USPS, after sorting the mail, may place the mail to be retrieved in a designated location where the third party can retrieve the mail.

The sorting facility is where the USPS sorts the snail mail into batches corresponding to the individual addresses and recipients. Thus, following sorting, the snail mail (if not intercepted) is ready for ‘last mile’ service. As discussed above, the ‘last mile’ service accounts for about 25 percent of the costs for the USPS. Because the third party retrieves the snail mail from the sorting facility prior to the ‘last mile’ service, the USPS saves money.

Now that the third party has intercepted/retrieved the snail mail, the third party can sort the mail into the various classes of mail (i.e., first class, second class, third class) and then convert the snail mail into electronic mail (step 608). The snail mail may be converted in a number of ways such as scanning the snail mail to create an electronic file or taking a digital image of the snail mail to create an electronic file as will be discussed below. The electronic file with then be available to the intended recipient over the internet (step 610). In one embodiment, the electronic files for only the first class mail will be made available to the intended recipient. In another embodiment, all of the snail mail images received by the third party will be make available to the intended recipient.

The snail mail will be maintained by the third party for an agreed upon time period, such as about 30 days, after which, the snail mail will be shredded. Upon viewing the electronic mail, the intended recipient may request the original snail mail to be delivered. Upon receiving such a request, the third party will send the regular mail in a package to be delivered to the intended recipient. The package will be delivered because the third party does not intercept packages. The USPS saves money on the cost of ‘last mile’ delivery because the snail mail is not physically delivered the ‘last mile’ by the USPS. The intended recipient can access the electronic files from anywhere in the world having an internet connection. Therefore, the intended recipient has the convenience of electronic mail anywhere in the world and the USPS saves money by eliminating the ‘last mile’ delivery.

By retrieving snail mail at the intended recipient's mailbox and converting the snail mail into electronic format, the intended recipient never needs to go to their mailbox again. Rather, all of their snail mail will be available to the intended recipient electronically. Additionally, if the intended recipient would like the actual snail mail, the third party who retrieved the snail mail can hand deliver the snail mail to the intended recipient. Thus, a convenient manner of receiving snail mail delivered by the USPS is achieved.

While the foregoing is directed to embodiments of the present invention, other and further embodiments of the invention may be devised without departing from the basic scope thereof, and the scope thereof is determined by the claims that follow.

1. A method, comprising:
retrieving paper based mail addressed to an intended recipient at the mailbox that services the intended recipient's residence or business;
converting the retrieved mail into an electronic file of the retrieved mail; and
permitting access to the electronic file by the intended recipient.

2. The method of claim 1, wherein the intended recipient's mailbox is a community mailbox.

3. The method of claim 1, further comprising sorting the retrieved mail into first class mail and second class mail, wherein the converting comprises taking a digital picture of the first class mail to create an electronic file of the first class mail and taking a digital picture of the second class make to create an electronic file of the second class mail.

4. The method of claim 3, wherein permitting access to the electronic file comprises permitting access to the electronic file of the first class mail.

5. The method of claim 1, wherein the converting comprises taking a digital picture of the retrieved mail and creating an electronic file.

6. The method of claim 5, wherein creating an electronic file comprises creating a first electronic file of the digital picture having a first number of megapixels, creating a second electronic file of the digital picture having a second number of megapixels that is greater than the first number of megapixels.

7. The method of claim 6, wherein permitting access comprises permitting the intended recipient to access both the first electronic file and the second electronic file.

8. The method of claim 5, wherein the digital picture has undesired background in addition to the desired paper based mail, the method further comprising deleting the undesired background from the electronic file.

9. The method of claim 1, wherein permitting access comprises permitting the intended recipient to access the electronic file at a resolution selected by the intended recipient.

10. The method of claim 1, further comprising gaining access to the intended recipient's mailbox.

11. The method of claim 10, wherein gaining access comprises making a new key that is a copy of a key utilized to open the intended recipient's mailbox.

12. The method of claim 11, wherein gaining access further comprises receiving a picture or image of the key and making the new key based upon the image or picture.

13. A method of converting snail mail into electronic mail, comprising:
retrieving snail mail that is addressed to an intended recipient from a mailbox that services the intended recipient's residence or business;
sorting the retrieved snail mail into first class mail and second class mail;
converting the first class mail into an electronic file of the first class mail; and
permitting access to the electronic file by the intended recipient.

14. The method of claim 13, wherein the converting comprises taking a digital picture of the first class mail to create an electronic file of the first class mail.

15. The method of claim 14, wherein permitting access to the electronic file comprises permitting access to the electronic file of the first class mail.

16. The method of claim 13, wherein the converting comprises taking a digital picture of the retrieved snail mail and creating an electronic file.

17. The method of claim 16, wherein creating an electronic file comprises creating a first electronic file of the digital picture having a first number of megapixels, creating a second electronic file of the digital picture having a second number of megapixels that is greater than the first number of megapixels.

18. The method of claim 17, wherein permitting access comprises permitting the intended recipient to access both the first electronic file and the second electronic file.

19. The method of claim 16, wherein the digital picture has undesired background in addition to the desired paper based mail, the method further comprising deleting the undesired background from the electronic file.

20. The method of claim 13, wherein permitting access comprises permitting the intended recipient to access the electronic file at a resolution selected by the intended recipient.

21. The method of claim 13, further comprising gaining access to the intended recipient's mailbox.

22. The method of claim 21, wherein gaining access comprises making a new key that is a copy of a key utilized to open the intended recipient's mailbox.

23. The method of claim 22, wherein gaining access further comprises receiving a picture or image of the key and making the new key based upon the image or picture.

24. A method of converting snail mail into electronic mail, comprising:
retrieving snail mail that is addressed to an intended recipient from the intended recipient's mailbox that services the intended recipient's residence or business;
converting the snail mail into one or more electronic files containing images of the snail mail, the converting comprising:
taking a digital image of the mail, the digital image containing a background having a contrast with the mail;
removing the background from the digital image to create a modified image; and
saving the modified image as a plurality of electronic files, each file having a different resolution; and
permitting access to the electronic file by the intended recipient at a resolution selected by the intended recipient.

25. The method of claim 24, wherein the background is a checkerboard pattern.

26. The method of claim 25, wherein associating multiple images of the same resolution with a single piece of snail mail.

27. The method of claim 24, further comprising gaining access to the intended recipient's mailbox.

28. The method of claim 27, wherein gaining access comprises making a new key that is a copy of a key utilized to open the intended recipient's mailbox.

29. The method of claim 28, wherein gaining access further comprises receiving a picture or image of the key and making the new key based upon the image or picture.
